(19) United States
(12) Patent Application Publication
(10) Pub. No.: US 2024/0385953 A1
(43) Pub. Date: Nov. 21, 2024

(54) RESOURCE-OPTIMIZED PARAMETER VARIATION OF SCENARIOS

(71) Applicant: dSPACE GmbH, Paderborn (DE)

(72) Inventors: Thomas MISCH, Paderborn (DE); Simon GORDON, Paderborn (DE)

(73) Assignee: dSPACE GmbH, Paderborn (DE)

(21) Appl. No.: 18/667,582

(22) Filed: May 17, 2024

(30) Foreign Application Priority Data
May 17, 2023 (DE) 20 2023 102 672.9

(51) Int. Cl. G06F 11/36

(52) U.S. Cl. CPC G06F 11/3688; G06F 11/3684; G06F 11/3692

(57) ABSTRACT

A test system for applying a method for resource-optimized parameter variation of scenarios for testing at least one real and/or virtual system under test and/or for displaying test results. At least one scenario is provided, wherein the scenario is defined by at least one parameter and wherein the parameter is configured by at least one numeric value and/or text value, wherein the numeric value and/or the text value is configurable by additional numeric and/or text values. At least one scenario-based test is performed, wherein the scenario is defined by and is varied over configured parameters. The test results is outputted.

This nonprovisional application claims priority under 35 U.S.C. § 119 (a) to German Patent Application No. 20 2023 102 672.9, which was filed in Germany on May 17, 2023, and which is herein incorporated by reference.

### BACKGROUND OF THE INVENTION

### Field of the Invention

The invention relates to a test system for applying a method for resource-optimized parameter variation of scenarios for testing at least one real and/or virtual system under test and/or for displaying test results.

### Description of the Background Art

In scenario-based testing, scenarios are defined that can be referred to as an abstraction, for example of a traffic situation. A logical scenario here is the abstraction of a traffic situation with the road, the driving behavior, and the surrounding traffic, without concrete parameter values.

The logical scenario becomes a concrete scenario through the choice of concrete parameter values. Such a concrete scenario corresponds to an individual traffic situation in each case. The concrete scenarios can then be used in a scenario-based test.

In order to execute scenario-based tests, various system elements are required in addition to the test itself. These elements can be, for example, a system under test (SUT) or a test environment. Sensor data obtained from test drives, for example, and/or by other means can also be used for creating (virtual) scenario-based tests and/or simulations so that these data are used as input quantities in the scenario.

The system under test (SUT) in this case describes an element under test, such as a piece of ECU software (Electronic Control Unit) or a control unit. The test environment describes the environment in which the system under test is tested; in the case of scenario-based tests, the environment is partly determined by the scenarios.

An autonomous driving function or driver assistance system can also represent a system under test (SUT).

Driver assistance systems such as, e.g., adaptive cruise control and/or functions for highly automated driving can be verified or validated with the aid of various verification methods. Scenario-based testing can be implemented here as software-in-the-loop (SIL) or as hardware-in-the-loop (HIL).

The configuration of a scenario, and thus of a scenario-based test, is resource-intensive. In the event of a misconfiguration of a test, the subsequent result can be faulty test execution in conjunction with a test abort. As a result, computing time and/or computing resources are needlessly occupied and avoidable costs are incurred.

Accordingly, there is a need to improve existing methods and/or devices for configuration of an execution of a virtual scenario-based test and/or of a simulation of a vehicle device and/or of a vehicle function such that the configuration for the tester/user of the test system is simplified and misconfigurations are avoided.

### SUMMARY OF THE INVENTION

It is therefore an object of the invention to provide a test system for applying a method for resource-optimized parameter variation of scenarios for testing at least one real and/or virtual system under test and/or for displaying test results.

The method, which is executed by the test system, for resource-optimized parameter variation of scenarios for testing at least one real and/or virtual system under test and/or for displaying test results includes the following steps: Provision of at least one scenario, wherein the scenario is defined by at least one parameter and wherein the parameter is configured by at least one numeric value and/or text value, wherein the numeric value and/or the text value is configurable by additional numeric and/or text values; and Performance of at least one scenario-based test, wherein the scenario is defined by step a and is varied over the configured parameters; and Output of the test results.

Thus, the method includes a step for provision of a scenario. This includes the information for parameterization of the scenario. A scenario can be described by numeric values and/or text values.

A numeric parameter or value is a configuration quantity that can be specified by a numerical value.

A text parameter or value can be a configuration quantity that is specified by a text/string value and describes causal and/or physical contexts in the scenario. These contexts can be defined in advance or result from the scenario itself.

The required numeric and/or text values can be combined and nested together as desired.

In this case, individual numeric and/or text values can be chosen or, relative to numeric values, value ranges, so that numeric values can be varied over them. For text values, predefined lists can be specified and/or lists can be compiled over which a parameter variation then takes place. In this way, a predefined list of text parameters for weather can be prepared, for example, so that a scenario can be varied over all text values contained in the list, such as, e.g., sun, rain, or snow.

As a second step, the configured test should be performed/executed, wherein the defined numeric and/or text values are used for this purpose and the test is varied over the configured numeric and/or text values.

In a last step, the test results produced in step two are provided or output for follow-up tests.

The test system for applying a method for parameter variation and/or for displaying test results can include at least one hardware component and at least one simulation component for execution of a scenario-based test. To begin with, a hardware component is required for the test system or even for the system under test itself, depending on the example or test. As a result, a scenario-based test can be implemented as software-in-the-loop or as hardware-in-the-loop. Software-in-the-loop or hardware-in-the-loop methodology is known to one skilled in the art and is further detailed in the attached Appendix, which is incorporated herein by reference.

In an example, the test system for applying a method for parameter variation and/or for displaying test results can include only at least one simulation component, since both the system under test and the test system are represented in a cloud environment.

A scenario-based test, executed by the test system, additionally includes at least one ego vehicle that contains the system under test. In addition, fellow vehicles, arbitrary additional vehicles, can be part of the scenario.

In general the term “ego vehicle” can represent a virtual vehicle in the center of a simulation or a test, e.g. the vehicle for that a new function is to be developed or tested. Typically, one skilled in the art uses such to distinguish a central vehicle (“ego”) from other vehicles or traffic participants (pedestrians, bicycles, etc.) that are usually called “fellows” or “fellow vehicles” that appear in a simulation or test and can interact or have an impact on the ego. For example, there may be several vehicles in a scenario in order to test a function of the ego vehicle but these fellow vehicles may not have the function to be tested, e.g. automatic braking systems.

In the scenario-based test, the speed of the ego vehicle or of the fellow vehicles, for example, can be defined by numeric values. A distance between vehicles or a roadway width are also selectable through numeric values.

In addition to configuration through numeric values, a scenario can also be described through text values. More complex contexts in the scenario can be configured by this means, such as, e.g., the weather or an emotional state of the virtual driver. Causal and/or physical contexts in the scenario can be configured in a simple manner through text values. This reduces effort for the user of the test system and prevents faulty configurations. A nesting or coupling of numeric and/or text values is also possible.

Oftentimes, errors first become apparent in the course of the simulation and then lead to a test abort. As a result, computing resources and time have then already been expended. Avoiding misconfigurations thus represents a substantial improvement in the test system, saving test resources.

For further optimization of the parameter variation of numeric and/or text parameters, test results must be produced and/or analyzed.

An analysis in this case contains the display of test results, for example grouped by text values employed. By this means, direct causal and/or physical contexts in the scenario can more easily be made visible and used for manual and/or automatic further parameter variation.

In particular, critical test results produced through critical parameters/parameter combinations configured through numeric and/or text values must be analyzed and/or displayed.

Critical parameters offer targeted options for further parameter variation. Moreover, test coverage is important for precisely these values. A structuring of the test results by text values in which critical values were identified allows a user of the test system to obtain a quick overview and initiate appropriate follow-up tests. Automatically generated new configurations of scenarios are also possible on this basis. Conventionally, a scenario-based test is a virtual test and can also be supported by additional algorithms; in particular, an Intelligent Test Control algorithm is capable here of identifying and executing specific test cases of interest within a predetermined parameter space. Text values can also be used in this case.

In this process, test results can be displayed in different tabs corresponding to the configuration, and the significance of text and/or numeric parameters can be illustrated by different sizes in a word cloud.

Many known methods for structuring are known that can be integrated into the display of the test results.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation for distinguishing driving situations/scenarios in a manner according to the invention;

FIG. 2 shows a schematic view of an example according to the invention for parameterization of text and numeric parameters;

FIG. 3 shows a schematic view that indicates a boundary between critical and noncritical test results;

FIG. 4 shows a schematic representation of a linking of text and numeric parameters in a manner according to the invention;

FIG. 5 shows a schematic view of an example according to the invention for parameterization of text and numeric parameters;

FIG. 6 shows a schematic view of an example according to the invention for the display of test results based on scenario-based tests parameterized with text and/or numeric parameters;

FIG. 7 shows a schematic view of an example according to the invention for the display of test results based on scenario-based tests parameterized with text and/or numeric parameters;

FIG. 8 shows a schematic view of the method for resource-optimized parameter variation of scenarios for testing at least one real and/or virtual system under test and/or for displaying test results;

FIG. 9 shows a schematic view of an example according to the invention for the display of test results based on scenario-based tests parameterized with text and/or numeric parameters; and

FIG. 10 shows a schematic view of an example according to the invention for the display of test results based on scenario-based tests parameterized with text and/or numeric parameters.

### DETAILED DESCRIPTION

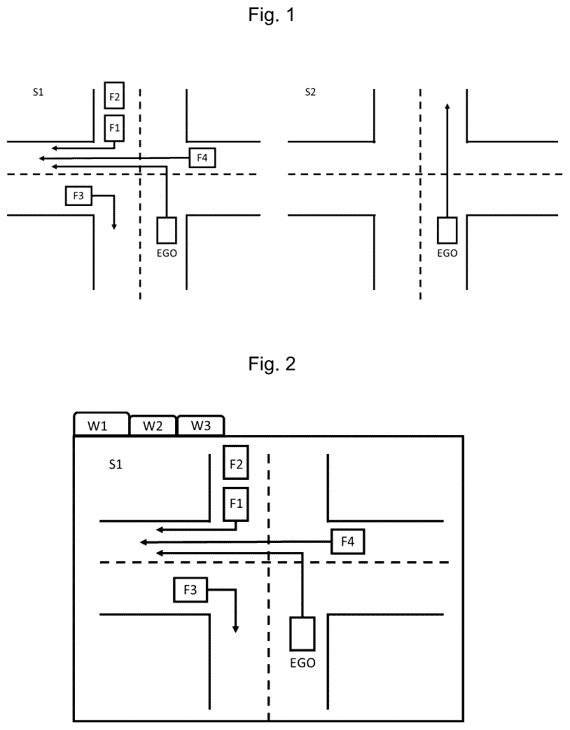

FIG. 1 describes two different scenarios S1 and S2. The area of an intersection is represented in each. An ego vehicle (Ego) is represented in both scenarios S1 and S2. In S1, the ego vehicle (Ego) is performing a turning maneuver. The ego vehicle is also the “System under Test” (SUT). Four fellow vehicles (F1 to F4) are involved here. In S2, the ego vehicle is following the driving route straight ahead with no fellow vehicles involved. Accordingly, there are differences in the environmental parameters as well as in driving situation parameters. The goal in the scenarios can be the testing and simulation of a smart cruise control, for example.

The testing and simulation of such a smart cruise control may require multiple test follow-ups in order to obtain a valid test result. Driving data from real trips (fleet operation/regular driving) can be used in order to make a suitable selection of scenarios and to find a sufficiently good parameterization so that meaningful tests can be performed. Weather conditions, for example, can play an important role in this case. Numerous test results are produced over at least one and/or also a number of test executions, and can be analyzed automatically through selected KPIs. One example for analysis through a KPI would be an evaluation of contexts in collision rates, such as, e.g.: When at least 10 test drives have been completed, examine the collision rate with respect to the test kilometers driven in simulation; For an average of 2 collisions (including near collisions) per 1,000 km, only a limited release of the driving function is allowed; For 3 collisions (including near collisions) per 1,000 km, a release of the driving function is only possible with conditions; and/or For 4 collisions (including near collisions) per 1,000 km, the current test process is aborted and further optimization of the driving function is necessary.

If all test drives with the first scenario were executed in simulation and no collision has occurred, a release can be considered. In this way, a degree of fulfillment of the requirements on the function under test and a release of the function can be specified by means of the evaluation through KPIs.

If it should turn out that collisions occur only under certain weather conditions, conclusions for the optimization of the driving function can again be provided through this means, and also restrictions for a release of the driving function.

For the purpose of simplification, such weather specifications can be accomplished through the use and configuration of text parameters (Text_P). In this way, appropriate configurations can quickly be correctly performed and displayed for the user of the test system.

Such a configuration is shown in FIG. 2. Here, the scenario S1 was chosen and the weather conditions W1, W2, and W3 configured as parameter variations over text parameters/values (Text_P). Results and possible driving routes can be indicated quickly, and thus influence the efficiency of the test process.

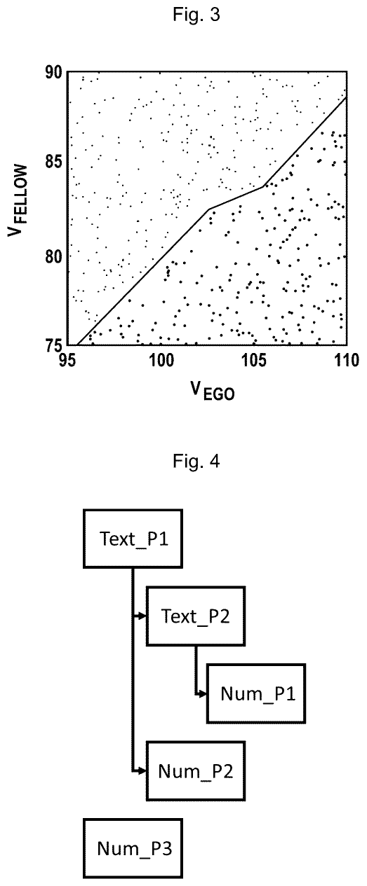

FIG. 3 shows an evaluation in accordance with the invention of the test results, for example by means of a KPI that is represented by a function that indicates a boundary between critical and noncritical test results. The points shown are simulated test results. Alternatively, they could also be approximated test results.

The test results can be produced through numeric and/or text values (Num_P/Text_P).

The function represented is the safety objective function, which has a numeric value that has a minimum value when there is a safety distance between the ego vehicle (EGO) and the other motor vehicle, the fellow vehicle (FELLOW), of ≥ VFELLOW×0.55, has a maximum value when there is a collision between the ego vehicle (EGO) and the other motor vehicle, and has a numeric value that is greater than the minimum value when there is a safety distance between the motor vehicle and the other motor vehicle of ≤ VFELLOW×0.55. Results over a safety objective function can be observed through KPIs over at least one and/or multiple test executions. Results of the evaluation can be taken into consideration for deciding on the release of a driving function. The test results are produced here through a combination of numeric and/or text values (Num_P/Text_P) as input for the corresponding test run. Shown in FIG. 3 are the speeds of the ego vehicle (EGO) and fellow vehicle (FELLOW) as numeric values (Num_P). In addition, however, other text values (Text_P) such as weather conditions or emotion of the driver could also lead to the test results.

Alternatively to the safety objective function, a comfort objective function or an efficiency objective function can, for example, be simulated and/or approximated, which has a numeric value that has a minimum value in the case of no change in the acceleration of the motor vehicle, has a maximum value when there is a collision between the ego vehicle (Ego) and the other motor vehicle, and, when there is a change in the acceleration of the ego vehicle (Ego), has a numeric value between the minimum value and the maximum value as a function of the amount of the change in the acceleration. The majority of driving situation parameters, in particular the speed VEGO of the ego vehicle (Ego) and the speed VFELLOW of the other motor vehicle, the fellow vehicle, are produced within the predetermined definition range by a simulation, for example.

FIG. 4 shows a schematic representation of a linking/nesting of text and numeric parameters (Text_P/Num_P) in a manner according to the invention. In this case, FIG. 4 shows that the text parameter Text_P1 is composed of the parameters Text_P2 and Num_P2. A further subdivision/nesting is also possible. Thus the text parameter Text_P2 is in turn formed by a numeric parameter Num_P1. This is meant to illustrate that an arbitrarily deep nesting is possible, and in the same way as in the case of the numeric parameter Num_P3, there is also no further execution of the parameters disclosed by the present invention.

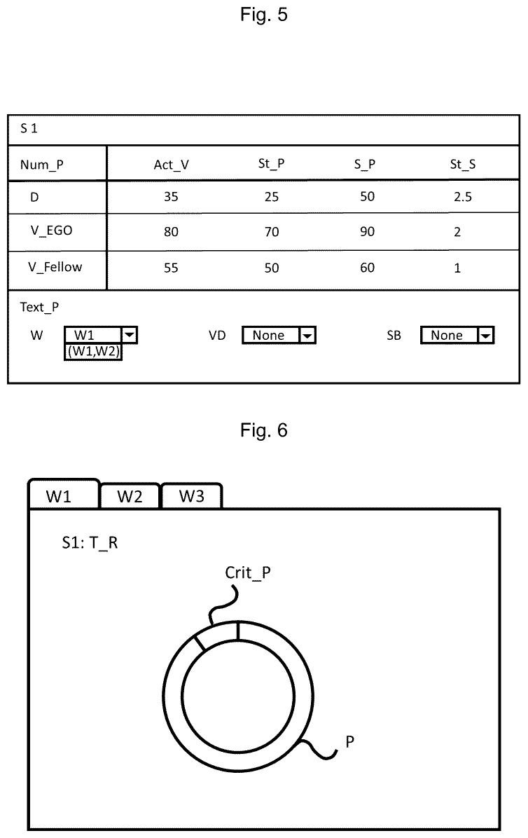

FIG. 5 discloses a schematic view of an example according to the invention for parameterization of text and numeric parameters. To this end, there are parameters that normally are represented by numeric values. The speed of an ego vehicle (V_EGO) or the speed of a fellow vehicle (V_Fellow) is given for this purpose in FIG. 5. Here, a detailed setting of the parameters by means of a start and end speed is provided, as is the specification of a step size of the parameters. It would likewise be possible according to the invention to provide a representation of the speeds through a text parameter such as, for instance, speeds of “fast,” “moderate,” “slow.” This depends substantially on the corresponding scenario and the desired scope of testing. In addition, the configuration of text parameters is indicated in FIG. 5. The configuration of the text parameters relating to the weather (W), the road condition (SB), or the emotions of the virtual driver (VD) is specified for this purpose. Weather conditions, such as rain, snow, ice, or sun, are possible that affect test results in the scenario. For a tester to manually perform such a configuration through numeric values is time-consuming and error-prone. Consequently, considerable resources can be saved by the present invention.

Individual text parameters (Text_P) with freely definable values can be chosen, or a predefined list of text parameter values (Text_P). A simple variation over text parameters (Text_P) can then take place for a scenario over the predefined list.

FIG. 6 shows a schematic view of an example according to the invention for the display of test results based on scenario-based tests parameterized with text and/or numeric parameters. Test results for the scenario S1 are represented here. Results for the scenario S1 are presented, grouped by text parameters W1 to W3. For each variation of these text parameters W1 to W3, the results are shown according to the tests that satisfy a performance criterion and the tests in which errors or undesirable conditions (Crit_P) have occurred. Various graphical options for displaying the information are given here and are intended to be included by the invention.

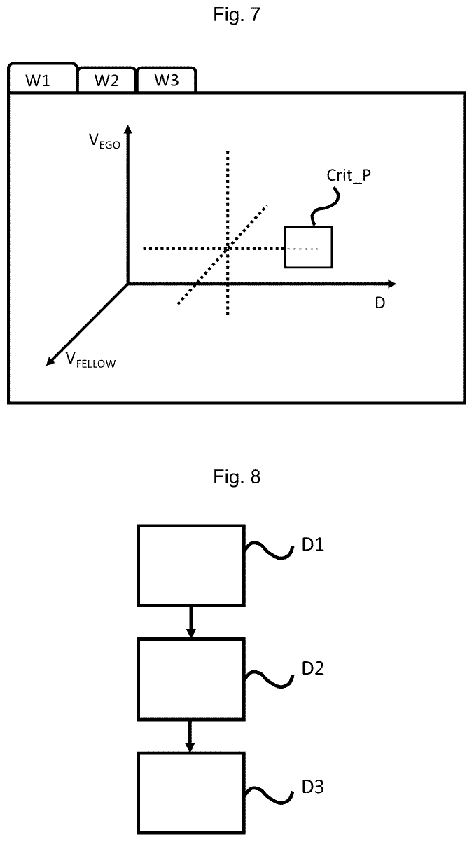

FIG. 7 shows another schematic view of an example according to the invention for the display of test results based on scenario-based tests parameterized with text and/or numeric parameters. A representation grouped by text parameters W1 to W3 is again shown here. W1 to W3 can be weather conditions sun, rain, or snow, for example. In this case, selected numeric parameters (V_EGO, V_FELLOW, D) are spanned under the condition of the text parameters W1 to W3 for a scenario. Successful (P) and critical (Crit_P) tests/parameter combinations are again shown in this parameter space.

FIG. 8 shows a schematic view of the method for resource-optimized parameter variation of scenarios(S) for testing at least one real and/or virtual system under test (SUT) and/or for displaying test results (T_R).

To this end, firstly a scenario(S) is provided in step D1, wherein the scenario(S) is defined by at least one parameter and wherein the parameter is configured by at least one numeric value (Num_P) and/or text value (Text_P), wherein the numeric value (Num_P) and/or the text value (Text_P) is configurable by additional numeric (Num_P) and/or text values (Num_P/Text_P). Such a nested configuration is also shown in FIG. 4.

As the second step (D2), at least one scenario-based test is performed, wherein the scenario is defined by step a.

In the last step D3, the test results (T_R) are output.

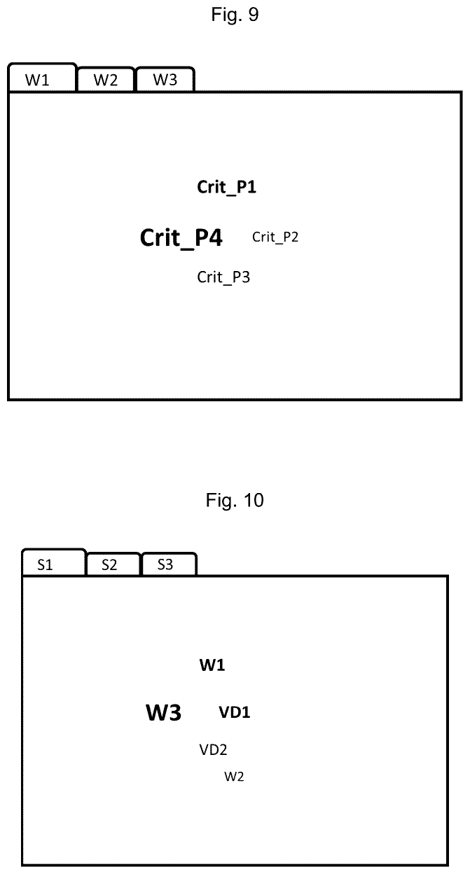

FIG. 9 shows a schematic view of an example according to the invention for the display of test results based on scenario-based tests parameterized with text and/or numeric parameters. In the example given in FIG. 5, critical parameters, which is to say parameters that lie outside a defined value range or lead to a collision, are displayed in a word cloud for each variation of the text parameters for this purpose. A variation of different weather conditions W1 to W3 and critical parameters that have correspondingly arisen has been represented here as an example. By means of critical parameters Crit_P1 to Crit_P4 represented with different sizes and weights, weak points can be perceived very quickly by the tester so that follow-up tests can be created manually and/or automatically based thereon. The critical parameters (Crit_P1 to Crit_P4) can be numeric parameters and/or text parameters in this case.

FIG. 10 shows another schematic view of an example according to the invention for the display of test results based on scenario-based tests parameterized with text and/or numeric parameters. In the example given in FIG. 10, the word cloud is formed from the relevance of the text parameters (W1 to W3 and VD1 to VD2) relative to different scenarios (S1 to S3).

A visual display of relevant parameters can be represented according to the invention in different variants and should not be limited by the examples given.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A test system for applying a method for resource-optimized parameter variation of scenarios to test at least one real and/or virtual system under test and/or for displaying test results, the method comprising:
providing at least one scenario, the scenario being defined by at least one parameter that is configured by at least one numeric value and/or text value, the numeric value and/or the text value being configurable by additional numeric and/or text values;
performing at least one scenario-based test that is defined by the scenario and is varied over the configured parameters; and
outputting the test results.

2. The test system according to claim 1, wherein the test system includes at least one hardware component and at least one simulation component for execution of a scenario-based test.

3. The test system according to claim 1, wherein the scenario includes at least one ego vehicle and/or a fellow vehicle, wherein the at least one ego vehicle is the vehicle with the system under test and a fellow vehicle is an arbitrary additional vehicle in the scenario.

4. The test system according to claim 1, wherein numeric values for defining a scenario include a speed of the vehicles and/or distance between vehicles and/or number of vehicles and/or a roadway width.

5. The test system according to claim 1, wherein text values are predefined as individual values or lists of values, wherein the definition of the scenario includes information on weather in the scenario, a road condition, or emotions of a virtual driver, and wherein causal and/or physical contexts of numeric values are taken as a basis in the configuration of text values.

6. The test system according to claim 1, wherein test results are produced with the use of the scenario defined by numeric and/or text values.

7. The test system according to claim 1, wherein configuration effort for scenario-based tests are saved and faulty configurations prevented through the use of text values, via which computing resources are reduced.

8. The test system according to claim 1, wherein a display of test results contains results that have arisen through a variation of text values and permits an analysis of the test results over text values.

9. The test system according to claim 1, wherein an analysis of the test results over text values permits a display of the test results by text value, and critical test results and thus critical parameters are represented and provided for further tests.

10. The test system according to claim 1, wherein the display of test results provides critical test results, and thus critical parameters based on text values in a word cloud.
